(19) United States
(12) Patent Application Publication
(10) Pub. No.: US 2015/0188202 A1
(43) Pub. Date: Jul. 2, 2015

(54) BATTERY MODULE

(71) Applicants: UER Technology (SHENZHEN) LIMITED, Shenzhen (CN); UER Technology Corporation, Miaoli County (TW)

(72) Inventors: RAY-TANG SUN, Miaoli (TW); TSUNG-HSIEN CHUANG, Miaoli (TW); CHENG-GHI FANG, Miaoli (TW); WEN-HSIEN CHEN, Miaoli (TW)

(21) Appl. No.: 14/573,270

(22) Filed: Dec. 17, 2014

(30) Foreign Application Priority Data
Dec. 31, 2013 (TW) 102149355

(51) Int. Cl. H01M 10/613; H01M 10/6552; H01M 2/10; H01M 10/42; H01M 6/50; H01M 10/656

(52) U.S. Cl. CPC H01M 10/5004; H01M 6/5011; H01M 6/5038; H01M 10/5061; H01M 2/1016; H01M 10/4207; H01M 10/5048

(57) ABSTRACT

A battery module includes a base, a battery assembly supported by the base and including one or more battery units, and a heat dissipation unit for dissipating heat created by the one or more battery units. Each battery unit includes two battery cells aligned with and spaced from each other. The heat dissipation unit includes one or more heat-conducting elements, a cooling box, and one or more connecting elements. Each battery unit has at least one heat-conducting element in contact with side surfaces of the two battery cells at the same side and coupled to one of the one or more connecting elements. Each connecting element is positioned between the two battery cells of one of the one or more battery units and secured to the cooling box to transmit the heat from the one or more heat-conducting elements to the cooling box.

### CROSS-REFERENCE TO RELATED APPLICATIONS

This application is related co-pending U.S. patent applications of Attorney Docket No. US54737, US54738, and US54739, each entitled “BATTERY MODULE”, and each invented by Sun et al. These applications have the same assignee as the present application.

The above-identified applications are incorporated herein by reference.

### FIELD

The present disclosure relates to a battery module including more than one battery cell.

### BACKGROUND

A lot of heat can be created during use of a battery module comprising a plurality of battery cells. Effective heat dissipation is needed for the battery module.

### BRIEF DESCRIPTION OF THE DRAWINGS

Implementations of the present technology will now be described, by way of example only, with reference to the attached figure.

FIG. 1 is an exploded, isometric view of a battery module according to an exemplary embodiment.

FIG. 2 is a partially exploded, isometric view of the battery module of FIG. 1.

FIG. 3 is an assembled, isometric view of the battery module of FIG. 1.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures, and components have not been described in detail so as not to obscure the related relevant feature being described. Also, the description is not to be considered as limiting the scope of the embodiments described herein. The drawings are not necessarily to scale and the proportions of certain parts have been exaggerated to better illustrate details and features of the present disclosure.

Several definitions that apply throughout this disclosure will now be presented.

The term “substantially” is defined to be essentially conforming to the particular dimension, shape or other word that substantially modifies, such that the component need not be exact. For example, substantially cylindrical means that the object resembles a cylinder, but can have one or more deviations from a true cylinder. The term “comprising,” when utilized, means “including, but not necessarily limited to”; it specifically indicates open-ended inclusion or membership in the so-described combination, group, series and the like.

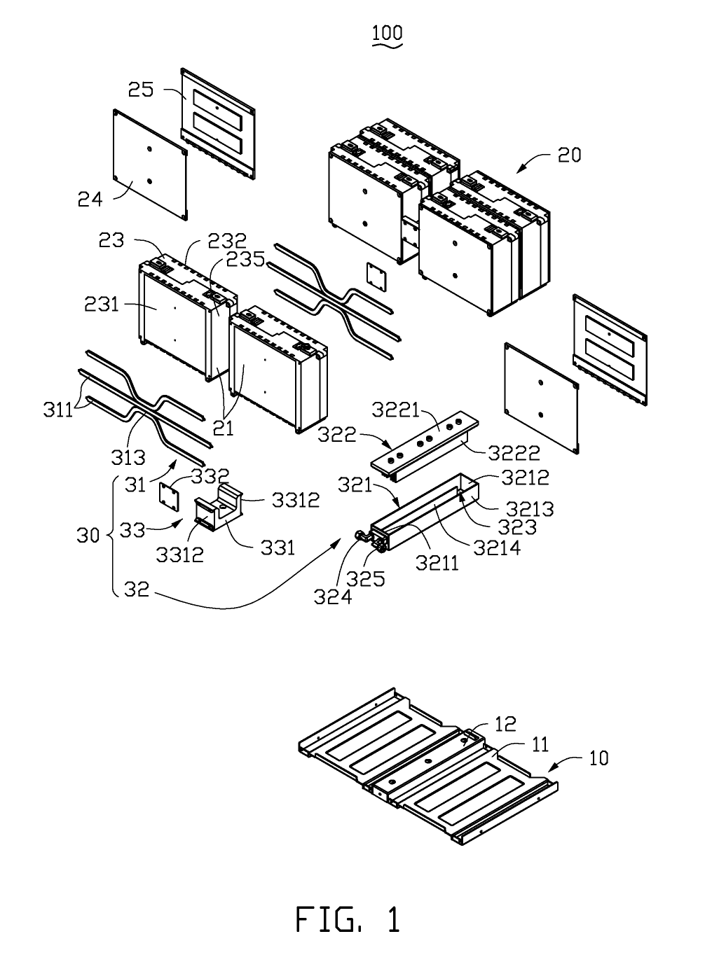

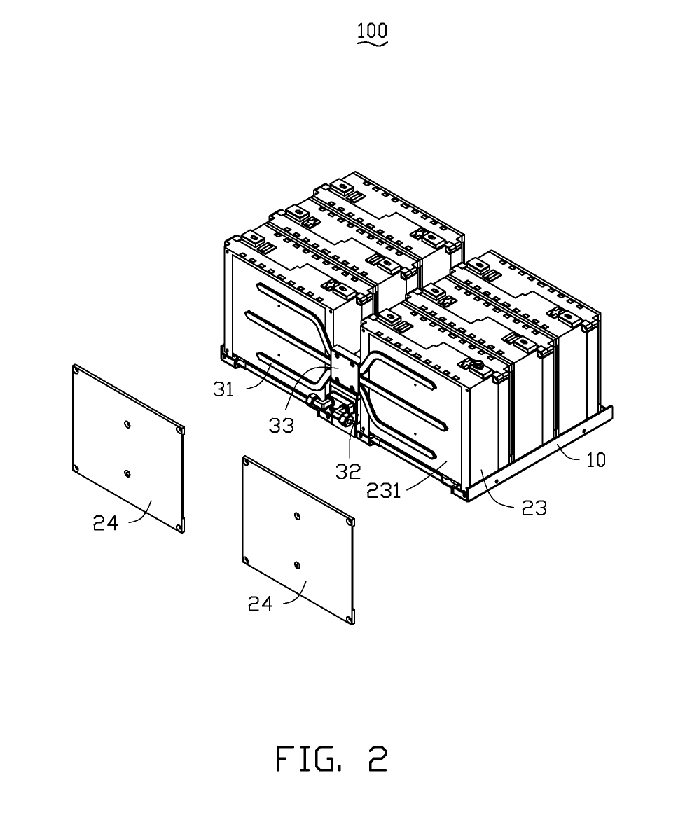

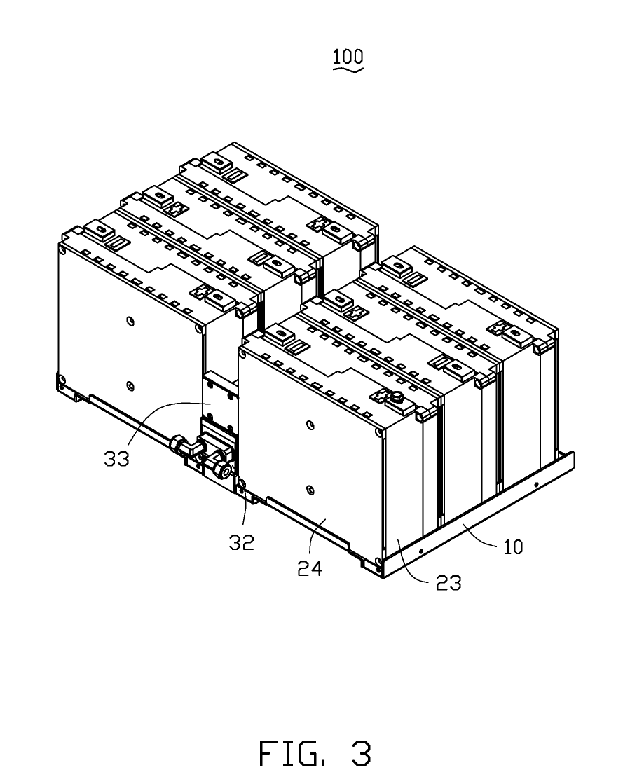

FIG. 1 through FIG. 3 illustrate a battery module 100 comprising a base 10, a battery assembly 20 supported by the base 10, and a heat dissipation unit 30. The battery assembly 20 comprises one or more battery units 21. Each battery unit 21 comprises two battery cells 23 aligned with and spaced from each other. The heat dissipation 30 is configured to dissipate heat created by the battery cells 23. The heat dissipation 30 comprises one or more heat-conducting elements 31, a cooling box 32, and one or more connecting elements 33. The one or more connecting elements 33 are heat-conductive. The one or more heat-conducting elements 31 are configured to transmit the heat from the battery cells 23. Each battery unit 21 has at least one heat-conducting element 31 attached to and in contact with two side surfaces 231 of the two battery cells 23 at the same side, with a substantially middle portion of the heat-conducting element 31 coupled to one of the one or more connecting elements 33. Each of the one or more connecting elements 33 is positioned between the two battery cells 23 of one of the one or more battery units 21 and secured to the cooling box 32 to transmit the heat from the one or more heat-conducting elements 31 to the cooling box 32.

The base 10 is configured to secure and support the battery assembly 20 and the heat dissipation unit 30. The base 10 comprises a first support portion 11 for supporting the battery assembly 20 and a second support portion 12 for supporting the heat dissipation unit 30. The second support portion 12 is located at a substantially middle portion of the first support portion 11. In one embodiment, the second support portion 12 is substantially bar-shaped and protrudes from the first support portion 11.

In one embodiment, the battery assembly 20 comprises a plurality of battery units 21, and the battery units 21 are arranged in an orderly array. In the exemplary embodiment, each battery unit 21 has one connecting elements 33 positioned between the two battery cells 23 thereof, and has two corresponding heat-conducting elements 31 positioned at two opposite sides and in contact with opposite side surfaces 231, 232 of the two battery cells 23.

Each heat-conducting element 31 comprises a plurality of branches 311 extending substantially in the same plane. Each branch 311 can be strip-shaped. The branches 311 concentrate at the substantially middle portion to form a fixing portion 313 and extend away from each other at two ends of each branch 311. The fixing portion 313 of each heat-conducting element 31 is located at a space 235 between the two battery cells 23 of one of the one or more battery units 21 and is connected to the corresponding connecting element 32. The branches 311 of each heat-conducting element 31 are attached to and in contact with the side surfaces 231 of the corresponding battery cells 23. In one embodiment, the branches 311 are heat pipes which are configured to transfer heat between two solid interfaces.

Each battery cell 23 can further have a front cover 24 and a back cover 25 attached to the two opposite side surfaces 231, 232 to cover the branches 311.

The cooling box 32 is configured to radiate heat transmitted by the one or more heat-conducting elements 31. The cooling box 32 defines an interior space 323 to accommodate a cooling fluid, an inlet 324 to feed the cooling fluid into the interior space 323, and an outlet 325 to discharge the cooling fluid from the interior space 323, thereby allowing a circulation of the cooling fluid in the cooling box 32.

In one embodiment, the cooling box 32 comprises a main body 321 defining the interior space 323 and a cover 322. The main body 321 comprises a first end wall 3211, a second end wall 3212 opposite to the first end wall 3211, and two side walls 3213 connected to the first and second end walls 3211, 3212. The first end wall 3211, the second end wall 3212, and the two side walls 3213 surround the interior space 323. The first end wall 3211 defines the inlet 324 and the outlet 325. The inlet 324 and the outlet 325 each can be connected to a pipe, thereby allowing a circulation of the cooling fluid in the cooling box 32.

The cooling box 32 can further comprise a baffle 3214 positioned in the interior space 323. The baffle 3214 is connected to a portion of the first end wall 3211 located between the inlet 324 and the outlet 325 and extends towards the second end wall 3211. An end of the baffle 3214 away from the first end wall 3211 is spaced from the second end wall 3211. The baffle 3214 can lengthen a running path of the cooling fluid in the cooling box 32, causing enough contact between the cooling fluid and the cooling box 32 to facilitate removal of heat transmitted by the one or more heat-conducting elements 31, thereby improving heat dissipation efficiency.

The cover 322 covers on the main body 321 to close the interior space 323. The cover 322 comprises a cover board 3221 and a plurality fins 3222 connected to a surface of the cover board 3221 facing the interior space 323. The fins 3222 are substantially parallel to each other and are substantially parallel to the baffle 3214. The fins 3222 extend in the interior space 323 and are located at two sides of the baffle 3214 when the cover 322 covers on the main body 321. The cover board 3221 and the fins 3222 can be made of high heat-conductive material. In one embodiment, the cover board 3221 and the fins 3222 are made of the same material and are integrally formed together. The fins 3222 are configured to divide the cooling fluid in the interior space 323 into divisional streams, allowing an evenly heat dissipation of the cooling box 32 and improving the heat dissipation efficiency.

The one or more connecting elements 33 are configured to connect the one or more heat-conducting elements 31 to the cooling box 32. A number of the connecting elements 33 can be equal to a number of the battery unit 21. Each connecting element 33 comprises a connecting block 331 and two fastening boards 332. Each fastening board 332 is configured to fix one of the one or more heat-conducting elements 31 to the connecting block 331. The connecting block 331 defines two locking notches 3312 in two opposite ends. In one embodiment, each locking notch 3312 is defined by two flange portions protruding from a top edge and a bottom edge of the connecting block 331. The two fastening boards 332 are configured to fix the one or more heat-conducting elements 31 to the connecting block 331 by locking the fixing portion 313 in the locking notches 3312.

To assemble the battery module 100, the main body 321 is secured to the second support portion 12. The cover 322 is covered on the main body 321 and the fins 3222 extend into the interior space 323. One connecting block 331 is then secured to a surface of the cover 322 opposite to the fins 3222. A first battery unit 21 is positioned on the first support portion 11 with the two battery cells 23 located at two sides of the connecting block 331 and the cooling box 32. One heat-conducting element 31 is positioned at each side of the first battery unit 21, with the fixing portion 313 of each heat-conducting element 31 locked in the locking notches 3312 by one of the fastening board 332, and the branches 311 of each heat-conducting element 31 are in contact with the two sides surfaces 231, 232 of the battery cells 23 at the same side. The front covers 24 and the back covers 25 are then attached the opposite side surfaces 231 of each battery cell 23 to cover the branches 311. If the battery module 100 comprises more than one battery units 21, the other battery units 21 are assembled by a similar manner.

In use, the inlet 324 is connected to a feeding pipe and the outlet 325 is connected to a discharge pipe. A cooling fluid can be fed into the interior space 323 and flows in the interior space 323. Heat created by the battery cells 23 are conducted by the one or more heat-conducting elements 31 to the one or more connecting elements 33, and then transmitted to the cooling box 32 by the one or more connecting elements 33. The cooling fluid in the cooling box 32 takes away the heat, thereby dissipating the heat created by the battery cells 23.

The embodiments shown and described above are only examples. Many details are often found in the art such as the other features of a battery module. Therefore, many such details are neither shown nor described. Even though numerous characteristics and advantages of the present technology have been set forth in the foregoing description, together with details of the structure and function of the present disclosure, the disclosure is illustrative only, and changes may be made in the details, including in matters of shape, size, and arrangement of the parts within the principles of the present disclosure up to, and including the full extent established by the broad general meaning of the terms used in the claims. It will therefore be appreciated that the embodiments described above may be modified within the scope of the claims.

What is claimed is:

1. A battery module comprising:
a base;
a battery assembly supported by the base, the battery assembly comprising one or more battery units, each of the one or more battery units comprising two battery cells aligned with and spaced from each other; and
a heat dissipation unit to dissipate heat created by the battery cells;
wherein the heat dissipation unit comprises one or more heat-conducting elements, a cooling box, and one or more connecting elements which are heat-conductive, each battery unit has at least one heat-conducting element in contact with two side surfaces of the two battery cells at the same side and coupled to one of the one or more connecting elements, each of the one or more connecting elements is positioned between the two battery cells of one of the one or more battery units and secured to the cooling box to transmit the heat from the one or more heat-conducting elements to the cooling box.

2. The battery module of claim 1, wherein the base comprises a first support portion and a second support portion located at a substantially middle portion of the first support portion; the cooling box is secured to the second support portion; the one or more battery unit are positioned on the first support portion with the two battery cells of each battery unit located at two sides of the cooling box.

3. The battery module of claim 1, wherein each of the one or more heat-conducting elements comprises a plurality of branches extending substantially in the same plane; the branches concentrate at a substantially middle portion to form a fixing portion and extend away from each other at two ends of each branch; the fixing portion of each heat-conducting element is located at a space between the two battery cells of one of the one or more battery units and is connected to the corresponding connecting element; the branches of each heat-conducting element are attached to and in contact with the side surfaces of the corresponding battery cells.

4. The battery module of claim 3, wherein the branches are heat pipes.

5. The battery module of claim 3, wherein each battery cell has a front cover and a back cover attached to two opposite side surfaces of the battery cell to cover the branches.

6. The battery module of claim 1, wherein each connecting element comprises a connecting block and two fastening boards; each fastening board is configured to fix one of the one or more heat-conducting elements to the connecting block.

7. The battery module of claim 6, wherein the connecting block defines two locking notches in two opposite ends; each of the two fastening boards is configured to fix one of the one or more heat-conducting elements to the connecting block by locking the fixing portion in one of the locking notches.
